(19) United States
(12) Patent Application Publication
(10) Pub. No.: US 2026/0079019 A1
(43) Pub. Date: Mar. 19, 2026

(54) MOBILE OBJECT CONTROL DEVICE, METHOD OF CONTROLLING MOBILE OBJECT, AND STORAGE MEDIUM

(71) Applicant: HONDA MOTOR CO., LTD., Tokyo (JP)

(72) Inventors: Takahiko Hasegawa, Wako-shi (JP); Sango Matsuzaki, Wako-shi (JP)

(21) Appl. No.: 19/324,166

(22) Filed: Sep. 10, 2025

(30) Foreign Application Priority Data
Sep. 17, 2024 (JP) 2024-159838

(51) Int. Cl. G01C 21/36; G05D 1/246; G05D 1/622; G05D 101/10; G06T 7/73

(52) U.S. Cl. CPC G01C 21/3602; G05D 1/246; G05D 1/622; G06T 7/74; G05D 2101/10; G06T 2207/30252

(57) ABSTRACT

A mobile object control device acquires a plurality of map sets each including a plurality of the maps, performs a matching process for each of the map sets between each of the plurality of maps included in each map set and an image obtained by capturing an image of a surrounding situation of a mobile object, selects any of the plurality of map sets on the basis of a plurality of matching results corresponding to the plurality of map sets, and estimates the self-position of the mobile object on the basis of at least one of the maps included in the selected map set.

### CROSS-REFERENCE TO RELATED APPLICATION

Priority is claimed on Japanese Patent Application No. 2024-159838, filed Sep. 17, 2024, the content of which is incorporated herein by reference.

### BACKGROUND OF THE INVENTION

### Field of the Invention

The present invention relates to a mobile object control device, a method of controlling a mobile object, and a storage medium.

### Description of Related Art

Autonomous mobile robots that move autonomously to a destination while avoiding obstacles are known (see, for example, the following Patent Documents 1 and 2).

A visual positioning system disclosed in Patent Document 1 acquires an image by performing light irradiation for the purposes of estimating the self-position of a mobile device, detecting obstacles, and mapping, and performs positioning and navigation under various environmental lighting conditions using one map.

An autonomous mobile robot control system disclosed in Patent Document 2 includes a higher-level management device and an autonomous mobile robot, wherein the higher-level management device collects sunlight condition data corresponding to sunlight conditions within the movement range of the autonomous mobile robot, and the autonomous mobile robot executes a predetermined operation on the basis of optimal parameters that minimize the influence of the sunlight conditions corresponding to the sunlight condition data.
[Patent Document 1] PCT Japanese Translation Patent Publication No. 2021-532462
[Patent Document 2] Japanese Unexamined Patent Application, First Publication No. 2024-3637

### SUMMARY OF THE INVENTION

In the mobile device and the autonomous mobile robot described above, it is necessary to estimate self-positions using map data. However, in a case where a large number of pieces of map data are present, there is a problem in that the amount of processing required for estimating the self-positions increases as the amount of the map data increases. In a case where a single map is used as disclosed in Patent Document 1, there is a problem in that when the map has missing data, a mobile object cannot estimate its self-position.

The present invention was contrived in view of such circumstances, and one object thereof is to provide a mobile object control device, a method of controlling a mobile object, and a storage medium that make it possible to perform processes such as estimating the self-position while suppressing the amount of processing even in a case where a large number of pieces of map data are present.

In order to solve the above problem, the present invention adopts the following aspects.
(1) According to an aspect of the present invention, there is provided a mobile object control device including: a recognition unit configured to estimate a self-position of a mobile object on the basis of an image obtained by capturing an image of a vicinity of the mobile object and a map; a generation unit configured to generate a route from the mobile object to a destination on the basis of the estimated self-position, the destination, and the map; and a control unit configured to control the mobile object so that the mobile object moves to the destination along the generated route, wherein the recognition unit acquires a plurality of map sets each including a plurality of the maps, performs a matching process for each of the map sets between each of the plurality of maps included in each map set and an image obtained by capturing an image of a surrounding situation of the mobile object, selects any of the plurality of map sets on the basis of a plurality of matching results corresponding to the plurality of map sets, and estimates the self-position of the mobile object on the basis of at least one of the maps included in the selected map set.
(2) In the aspect of the above (1), the recognition unit may perform a plurality of matching processes corresponding to the plurality of map sets in parallel.
(3) In the aspect of the above (1), the recognition unit may select, from among the plurality of map sets, a map set with a least amount of information out of map sets whose degree of matching exceeds a threshold.
(4) In the aspect of the above (1), the recognition unit may perform the matching process when the mobile object is started up or when the degree of matching between an image obtained by capturing an image of the vicinity of the mobile object and a map included in the map set being referred to falls below a lower limit.
(5) In the aspect of the above (1), the plurality of maps included in each of the map sets may be maps that satisfy predetermined conditions.
(6) In the aspect of the above (5), each of the predetermined conditions may be a proximity of a position, a time, or lighting conditions.
(7) In the aspect of the above (1), the plurality of map sets may differ from other map sets in lighting conditions or sunlight conditions.
(8) In the aspect of the above (7), the plurality of map sets may differ from other map sets in obstacle conditions including an arrangement of obstacles.
(9) According to an aspect of the present invention, there is provided a method of controlling a mobile object, including: estimating a self-position of a mobile object on the basis of an image obtained by capturing an image of a vicinity of the mobile object and a map; generating a route from the mobile object to a destination on the basis of the estimated self-position, the destination, and the map; controlling the mobile object so that the mobile object moves to the destination along the generated route; and when the self-position is estimated, acquiring a plurality of map sets each including a plurality of the maps, performing a matching process for each of the map sets between each of the plurality of maps included in each map set and an image obtained by capturing an image of a surrounding situation of the mobile object, selecting any of the plurality of map sets on the basis of a plurality of matching results corresponding to the plurality of map sets, and estimating the self-position of the mobile object on the basis of at least one of the maps included in the selected map set.
(10) According to an aspect of the present invention, there is provided a computer readable non-transitory storage medium having a program stored therein, the program causing a computer to: estimate a self-position of a mobile object on the basis of an image obtained by capturing an image of a vicinity of the mobile object and a map; generate a route from the mobile object to a destination on the basis of the estimated self-position, the destination, and the map; control the mobile object so that the mobile object moves to the destination along the generated route; and when the self-position is estimated, acquire a plurality of map sets each including a plurality of the maps, perform a matching process for each of the map sets between each of the plurality of maps included in each map set and an image obtained by capturing an image of a surrounding situation of the mobile object, select any of the plurality of map sets on the basis of a plurality of matching results corresponding to the plurality of map sets, and estimate the self-position of the mobile object on the basis of at least one of the maps included in the selected map set.

According to the aspects of the above (1) to (10), it is possible to perform processes such as estimating the self-position while suppressing the amount of processing even in a case where a large number of pieces of map data are present.

### BRIEF DESCRIPTION OF THE DRAWINGS

FIG. 1 is a diagram illustrating an example of a configuration of a mobile object system 1 including a mobile object 100.

FIG. 2 is a perspective view illustrating an example of the mobile object 100.

FIG. 3 is a block diagram illustrating an example of a functional configuration of the mobile object 100.

FIG. 4 is a diagram illustrating an example of map information 222 in an embodiment.

FIG. 5 is a diagram illustrating an example of a matching process performed by a recognition unit 202 in the embodiment.

FIG. 6 is a diagram illustrating another example of the map information 222 in the embodiment.

FIG. 7 is a flowchart illustrating an example of a processing procedure of a control device 200 in the embodiment.

### DETAILED DESCRIPTION OF THE INVENTION

Hereinafter, an embodiment of a mobile object control device of the present invention, a method of controlling a mobile object, and a storage medium will be described with reference to the accompanying drawings.

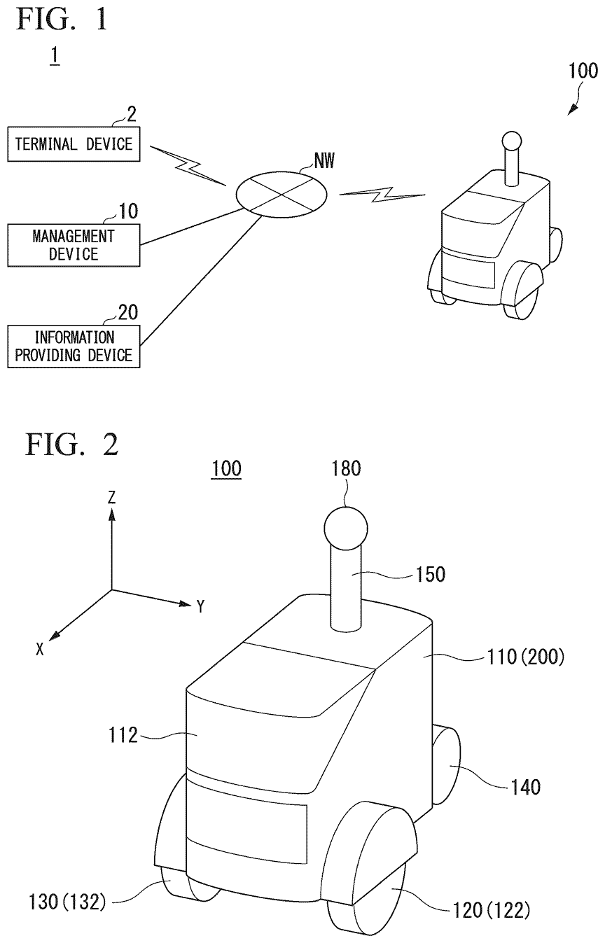

FIG. 1 is a diagram illustrating an example of a configuration of a mobile object system 1 including a mobile object 100.

The mobile object system 1 includes, for example, one or more terminal devices 2, a management device 10, an information providing device 20, and one or more mobile objects 100. These components communicate with each other, for example, through a network NW. The network NW is any network such as, for example, a LAN, a WAN, or an Internet line.

### Terminal Device

The terminal device 2 is a computer device such as, for example, a smartphone or a tablet terminal. The terminal device 2, for example, requests the management device 10 to provide authorization for use of the mobile object 100 on the basis of a user's operation, or acquires information indicating that use has been permitted.

### Management Device

In response to a request received from the terminal device 2, the management device 10 grants the authorization for use of the mobile object 100 to a user of the terminal device 2, or manages a reservation for use of the mobile object 100. The management device 10 generates and manages, for example, schedule information in which user identification information registered in advance and the date and time of the reservation for use of the mobile object 100 are associated with each other.

### Information Providing Device

The information providing device 20 provides the mobile object 100 with a position at which the mobile object 100 is present, a region through which the mobile object 100 moves, and map information on the surrounding region. In response to a request received from the mobile object 100, the information providing device 20 may generate a route to the destination of the mobile object 100, and provide the generated route to the mobile object 100.

### Mobile Object

The mobile object 100 is disposed at a predetermined position in a facility or a town. When a user wants to use the mobile object 100, the user can start using the mobile object 100 by operating its operating unit (not shown), or start using the mobile object 100 by operating the terminal device 2. For example, when a user goes shopping and has a lot of baggage, the user starts using the mobile object 100 and puts the baggage into the storage compartment of the mobile object 100. The mobile object 100 then moves together with the user so as to autonomously follow the user. With the baggage stored in the mobile object 100, the user can continue shopping or head to the next destination. For example, the mobile object 100 moves while moving on a sidewalk or a crosswalk on a roadway together with a user. The mobile object 100 can move in regions through which pedestrians can pass, such as a roadway and a sidewalk. For example, the mobile object 100 may be used in indoor or outdoor facilities or private lands, such as a shopping center, an airport, a park, or a theme park, and can move in regions through which pedestrian can pass.

The mobile object 100 may be capable of moving autonomously in a mode such as a guidance mode or an emergency mode in addition to (or instead of) the following mode in which it follows a user as described above.

The guidance mode is a mode in which a user is guided to a destination designated by the user, and the user is guided by moving autonomously in front of the user in accordance with the user's movement speed. For example, when a user is looking for a predetermined commercial product in a shopping center, and the user requests the mobile object 100 to guide him or her to the location of predetermined commercial product, the mobile object 100 guides the user to the location of the commercial product. This makes it possible for the user to easily find a predetermined commercial product. In a case where the mobile object 100 is used in a shopping center, the mobile object 100 or the information providing device 20 holds information in which the locations of commercial products, the locations of stores, the locations of facilities within a shopping center, and the like are associated with map information, as well as map information of the shopping center. This map information includes detailed map information including the widths of roads or passageways, and the like. The locations of commercial products, the locations of stores, the locations of facilities within a shopping center, and the like may also be included in the map information. In a case where a control device 200 stores map information 222 as will be described later, the mobile object 100 or the information providing device 20 does not need to hold the map information of the shopping center or the like.

The guidance mode may be a mode in which a user is guided to a destination estimated on the basis of information such as map information and the user's actions (including orientation, speed, behavior, and the like) even if the user does not designate a destination. For example, the mobile object 100 or the information providing device 20 may detect the orientation of the user from an image captured by a camera 180 to be described later, set a straight line representing the detected orientation of the user, and estimate, as a destination, a location that intersects the straight line or a location which is closest to it among locations registered in the map information. For example, the mobile object 100 or the information providing device 20 may register a plurality of gestures (such as, for example, a gesture of drinking a drink and a gesture of charging a mobile phone) in advance, collate the behavior of the user detected from an image with the registered gesture, and estimate, as a destination, a location that satisfies the requirements of the gesture (such as, for example, a restaurant or a recharging facility) among the locations stored in the map information. For example, the mobile object 100 or the information providing device 20 may estimate, as a destination, a location that has been most frequently set as a destination by a user in the past among the facilities stored in the map information.

The emergency mode is a mode in which, in a case where something unusual happens a user while moving with the user (for example, a case where the user falls), autonomous movement is performed to seek help from nearby people or nearby facilities in order to help the user. In addition to (or instead of) following and guiding as described above, the mobile object 100 may move while maintaining a moderate (neither too close nor too far) distance from the user.

The mobile object 100 is not limited to the above, and may be any object that a user can ride in, or may be, for example, a vehicle. The vehicle may be not only a four-wheeled vehicle, but also any vehicle that can move with three or two wheels. The vehicle may be capable of traveling on both a roadway and a sidewalk with a user on board.

FIG. 2 is a perspective view illustrating an example of the mobile object 100.

In the following description, the forward direction of the mobile object 100 is defined as a +x direction, the rearward direction of the mobile object 100 is defined as a −x direction, the leftward direction in the widthwise direction of the mobile object 100 with respect to the +x direction is defined as a +y direction, the rightward direction is defined as a −y direction, and the direction orthogonal to the x direction and the y direction, which is the height direction of the mobile object 100, is defined as a +z direction.

The mobile object 100 includes, for example, a base body 110, a door portion 112 provided on the base body 110, and wheels (a first wheel 120, a second wheel 130, and a third wheel 140) assembled to the base body 110. For example, a user can open the door portion 112 to put baggage into a storage compartment provided in the base body 110 or extract the baggage from the storage compartment. The first wheel 120 and the second wheel 130 are driving wheels, and the third wheel 140 is an auxiliary wheel (driven wheel). The mobile object 100 may be capable of moving using a configuration other than wheels, such as a caterpillar.

A cylindrical support 150 extending in the +z direction is provided on the surface of the base body 110 in the +z direction. The camera 180 that captures images of the vicinity of the mobile object 100 is provided on the end of the support 150 in the +z direction. The position at which the camera 180 is provided may be any position different from the above.

The camera 180 is, for example, a camera capable of capturing images of the vicinity of the mobile object 100 at a wide angle (for example, 360 degrees). The camera 180 may include a plurality of cameras. The camera 180 may be realized by a combination of, for example, a plurality of 120-degree cameras or a plurality of 60-degree cameras.

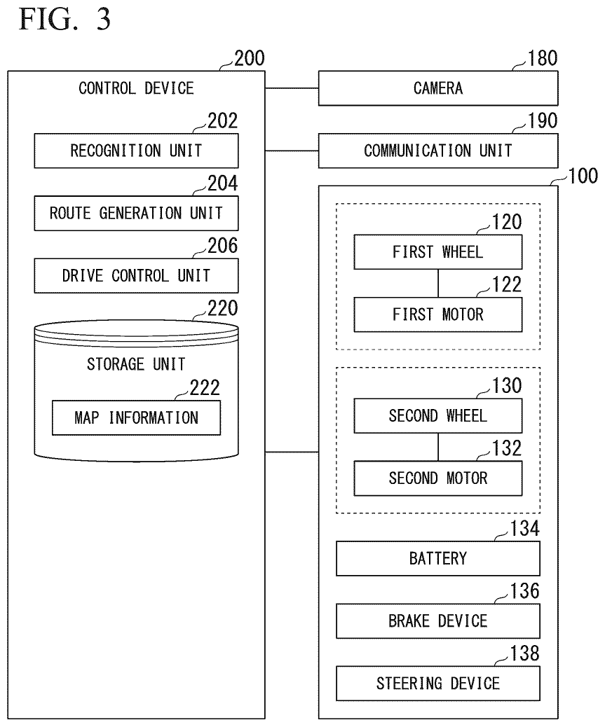

FIG. 3 is a block diagram illustrating an example of a functional configuration the mobile object 100.

In addition to the functional configuration shown in FIG. 2, the mobile object 100 includes a first motor 122, a second motor 132, a battery 134, a brake device 136, a steering device 138, a communication unit 190, and the control device 200. The first motor 122 and the second motor 132 are operated by electric power supplied from the battery 134. The first motor 122 drives the first wheel 120. The second motor 132 drives the second wheel 130. The first motor 122 may be an in-wheel motor provided on the wheel of the first wheel 120. The second motor 132 may be an in-wheel motor provided on the wheel of the second wheel 130.

The brake device 136 outputs a brake torque to each of the first wheel 120 and the second wheel 130 on the basis of an instruction from the control device 200. The steering device 138 includes an electric motor. The electric motor, for example, changes the direction of the first wheel 120 or the second wheel 130 by causing a force to act on a rack and pinion mechanism on the basis of the instruction from the control device 200 to change the course of the mobile object 100.

The communication unit 190 is a communication interface for communicating with the terminal device 2, the management device 10, or the information providing device 20.

### Control Device

The control device 200 includes, for example, a recognition unit 202, a route generation unit 204, a drive control unit 206, and a storage unit 220. The recognition unit 202, the route generation unit 204, and the drive control unit 206 are realized by, a hardware processor such as, for example, a central processing unit (CPU) executing a program (software). Some or all of these components may be realized by hardware (a circuit unit; including circuitry) such as a large scale integration (LSI), an application specific integrated circuit (ASIC), a field-programmable gate array (FPGA), or a graphics processing unit (GPU), and may be realized by software and hardware in cooperation. The program may be stored in a storage device such as a hard disk drive (HDD) or a flash memory (a storage device including a non-transitory storage medium) in advance, may be stored in a detachable storage medium such as a DVD or a CD-ROM (non-transitory storage medium), or may be installed by the storage medium being installed in a drive device.

The storage unit 220 is realized by a storage device such as a HDD, a flash memory, or a random access memory (RAM). The storage unit 220 stores the map information 222 which is referenced by the mobile object 100. The map information 222 is, for example, information indicating a map of the position at which the mobile object 100 is present, the region in which the mobile object 100 moves, the vicinity of the region, or the like provided by the information providing device 20. The map information 222 is, for example, information in which feature points included in a captured image captured by the camera 180 and position information are associated with each other. The map information 222 may be, for example, information including the positions of walls, obstacles, and the like detected by light detection and ranging (LiDAR). The map information 222 may be information including a region in which traveling is possible without walls, obstacles, and the like. The map information 222 may be information in which features included in an image, information indicating objects such as walls and obstacles detected by LiDAR, and position information are associated with each other.

A portion of or all of the functional configuration included in the control device 200 may be included in another device. For example, the other device and the mobile object 100 may communicate with each other and cooperate to control the mobile object 100.

The recognition unit 202 estimates the self-position of the mobile object 100 on the basis of a map set including a plurality of images obtained by capturing images of the vicinity of the mobile object 100 and a plurality of pieces of map information 222. The map set includes the plurality of pieces of the map information 222 as will be described later.

Specifically, the recognition unit 202 recognizes the positions of objects present in the vicinity of the mobile object 100 (distance from the mobile object 100 and direction relative to the mobile object 100) and states such as the speed and acceleration thereof on the basis of images captured by the camera 180. The objects include traffic participants, obstacles present in facilities or on roads, and the like. The recognition unit 202 recognizes and tracks the user of the mobile object 100. For example, the recognition unit 202 tracks the user on the basis of an image obtained by capturing an image of the user (for example, a facial image of the user) registered when the user uses the mobile object 100, or a facial image of the user (or feature amount obtained from the facial image of the user) provided by the terminal device 2 or the management device 10. The recognition unit 202 recognizes a gesture performed by the user. The mobile object 100 may be provided with a detection unit different from a camera such as a radar device or LiDAR. In this case, the recognition unit 202 recognizes the situation around the mobile object 100 using the detection results of a radar device or LiDAR instead of (or in addition to) images.

The recognition unit 202 creates map data representing the surrounding situation of the mobile object 100 on the basis of the estimated self-position. The map data created by the recognition unit 202 is stored as the map information 222. The map data created by the recognition unit 202 may be transmitted to the information providing device 20.

The route generation unit 204 generates a route for the mobile object 100 on the basis of the estimated self-position and the map information 222. In a case where a destination is set, the route generation unit 204 may generate a route for the mobile object 100 on the basis of the estimated self-position, the destination, and the map information 222. The destination indicates the user itself to be followed or a point within a predetermined range from the user in a case where the mobile object 100 is in following mode. For example, the route generation unit 204 may set a predetermined point diagonally behind the user as the destination so that the mobile object 100 can follow the user and be visible to the user. For example, the route generation unit 204 may determine a destination so that a distance from the user is maintained within a predetermined range on the basis of the walking speed of the user in order to prevent the destination from becoming too far away from the user. In the case of being in the guidance mode, for example, the location of a commercial product or a facility set by the user is displayed. In this case, the user designates the location of a commercial product or a facility, and the mobile object 100 collates the designated location of the commercial product or the facility with the map information 222, and sets the specified location of the commercial product or the facility as the destination as a result of the collation. In the case of being in the guidance mode, if the point set by the user is far from the current location of the mobile object 100, the route generation unit 204 may set the point set by the user as a final destination, and set a point within a predetermined range from the current location as a temporary destination.

In the guidance mode, the user does not necessarily have to set a destination, and the mobile object 100 may predict the direction in which the user moves and move autonomously in front of the user in accordance with the movement speed of the user. In this case, the route generation unit 204 may set the destination of the mobile object 100 as a point within a predetermined range in front of the user.

The route is a route that allows the mobile object 100 to reasonably reach the destination in consideration of the forward direction of the mobile object 100 (that is, the x direction of the mobile object 100). The route generation unit 204 generates a plurality of waypoints for reaching the destination from the current location, and generates a route by connecting the plurality of waypoints. The route generation unit 204 obtains, for example, the risk for each waypoint, and in a case where the obtained risk satisfies a criterion set in advance (for example, in a case where the risk of each waypoint is equal to or less than a threshold Th1) or in a case where the total value the obtained risks satisfies a criterion set in advance (for example, in a case where the total value of the risks is equal to or less than a threshold Th2), the route that satisfies the criterion is adopted as a target route along which the mobile object 100 is to move. Here, the risk indicates that the larger the value, the more the mobile object 100 should not enter or approach, and the closer the value is to zero, the more favorable it is for the mobile object 100 to pass through. Therefore, in general, as the distance to the position of a recognized object decreases, the value of the risk increases, whereas as the distance from the position of the recognized object increases, the value of the risk decreases.

The drive control unit 206 controls the motors (the first motor 122 and the second motor 132), the brake device 136, and the steering device 138 so that the mobile object 100 travels along the route generated by the route generation unit 204.

### Estimation of Self-Position

The recognition unit 202 acquires a plurality of map sets each including a plurality of maps, performs a matching process for each of the map sets between each of the plurality of maps included in each map set and an image obtained by capturing an image of the vicinity of the mobile object 100, selects any of the plurality of map sets on the basis of a plurality of matching results corresponding to the plurality of map sets, and estimates the self-position of the mobile object 100 on the basis of at least one of the map information 222 included in the selected map set.

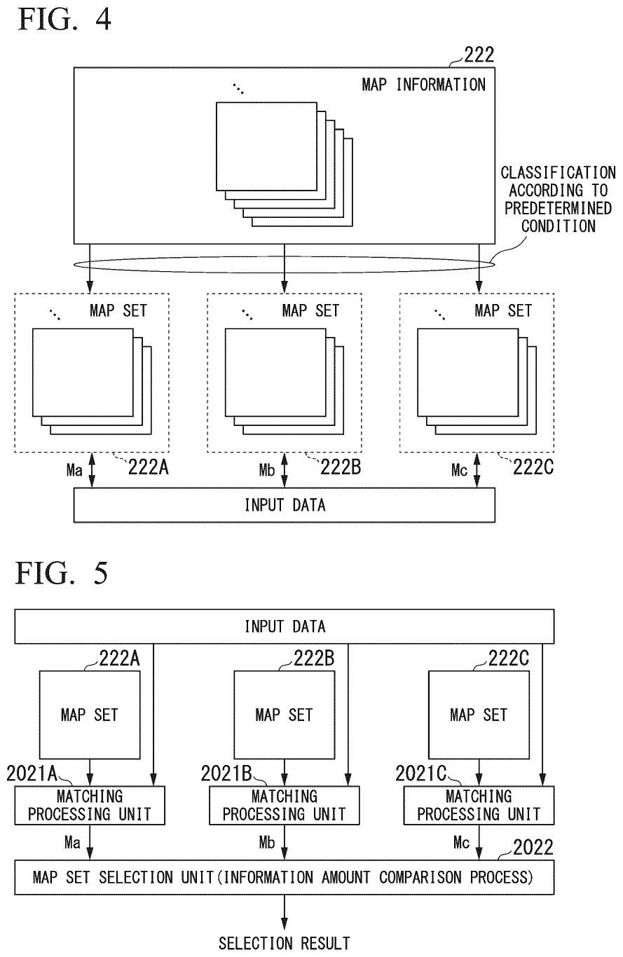

FIG. 4 is a diagram illustrating an example of the map information 222 in the embodiment.

The map information 222 includes a large number of maps. In the following description, each of a large number of maps is information in which a captured image of a region where the mobile object 100 moves, feature point information indicating feature points extracted from the captured image, position information, and attribute information are associated with each other. The attribute information is information indicating a predetermined condition for classifying the maps. The predetermined conditions are a position, a time, or lighting conditions. The predetermined conditions may be lighting conditions or sunlight conditions. The predetermined condition may be an arrangement of obstacles.

The map information 222 is divided into a plurality of map sets 222A, 222B, and 222C by classification according to a predetermined condition. That is, a plurality of maps included in each of the map sets 222A, 222B, and 222C are maps that satisfy the predetermined condition.

Each of the predetermined conditions is a proximity of a position, a time, or lighting conditions. For example, the map set 222A, the map set 222B, and the map set 222C may be divided by different positions (regions), may be divided by the time at which the captured image has been captured, may be divided by the lighting conditions, may be divided by the sunlight conditions, or may be divided by the arrangement of obstacles. The lighting conditions include illuminance, a lighting color, the number of lights, or the like. The sunlight conditions include the presence or absence of direct sunlight, the amount of light depending on the weather, or the like. The arrangement of obstacles includes the arrangement of seats, the arrangement of fixtures in a store, or the like.

The plurality of map sets 222A, 222B, and 222C may differ from other map sets in lighting conditions or sunlight conditions.

Each of the plurality of map sets 222A, 222B, and 222C includes one or a plurality of maps. Each of the plurality of map sets 222A, 222B, and 222C and the captured image captured by the camera 180 serving as input data are collated with each other through a matching process. For example, as the number of matches between feature points of the captured image and feature points of the maps included in the map set becomes greater, the degree of matching of the map set becomes higher. The degree of matching is a degree to which the captured image and the map information 222 match each other, but the degree of matching may be replaced with the degree of similarity between the captured image and the map information 222, or may be replaced with a value representing the correlation between the captured image and the map information 222.

FIG. 5 is a diagram illustrating an example of a matching process performed by the recognition unit 202 in the embodiment.

The recognition unit 202 may perform a plurality of matching processes corresponding to a plurality of map sets in parallel.

When the matching process is performed, the recognition unit 202 activates a plurality of matching processing units 2021A, 2021B, and 2021C corresponding to the map sets 222A, 222B, and 222C, and a map set selection unit 2022.

The number of matching processing units corresponds to the number of map sets used in the matching process. The matching processing unit 2021A calculates a degree of matching Ma by matching the map set 222A with the captured image serving as input data. The matching processing unit 2021B calculates a degree of matching Mb by matching the map set 222B with the captured image serving as input data. The matching processing unit 2021C calculates a degree of matching Mc by matching the map set 222C with the captured image serving as input data.

The map set selection unit 2022 selects any one of the plurality of map sets on the basis of the plurality of degrees of matching acquired from the matching processing units 2021A, 2021B, and 2021C. The map set selection unit 2022 may select a map set corresponding to the highest degree of matching among the degrees of matching. In a case where there are a plurality of degrees of matching exceeding a threshold among the degrees of matching, the map set selection unit 2022 may perform an information amount comparison process of comparing the information amounts of the map sets and select a map set with the lowest information amount. The map set selection unit 2022 outputs information indicating the map set as a selection result.

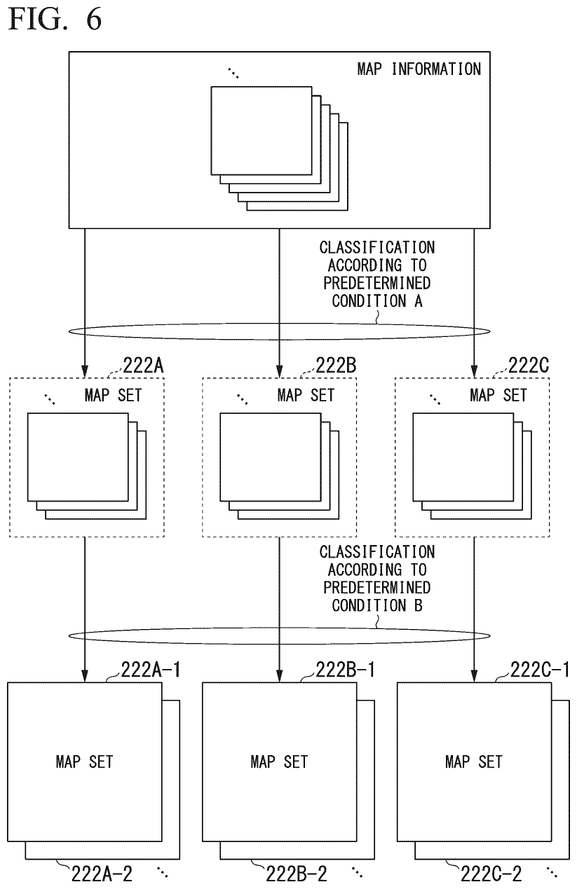

FIG. 6 is a diagram illustrating another example of the map information 222 in the embodiment.

The recognition unit 202 may divide the map information 222 into the plurality of map sets 222A, 222B, and 222C by classification according to a predetermined condition A, and further divide the map set 222A, 222B, and 222C into a plurality of map sets 222A-1, 222A-2, . . . , 222B-1, 222B-2 . . . , 222C-1, 222C-2 . . . by classification according to a predetermined condition B. The predetermined condition A and the predetermined condition B are conditions different from each other. For example, the predetermined condition A is a location where the mobile object 100 moves, and the predetermined condition B is today's sunlight condition.

In a case where the degree of matching between the map set 222A and the captured image is lower than a threshold according to the predetermined condition A, the recognition unit 202 may divide the map set 222A into the plurality of map sets 222A-1 and 222A-2 by classification according to the predetermined condition B, and calculate the degree of matching between each of the plurality of map sets 222A-1 and 222A-2 and the captured image. This enables the recognition unit 202 to acquire a map set with a high degree of matching by further narrowing down the plurality of maps included in the map set according to the predetermined condition B.

### Processing Procedure

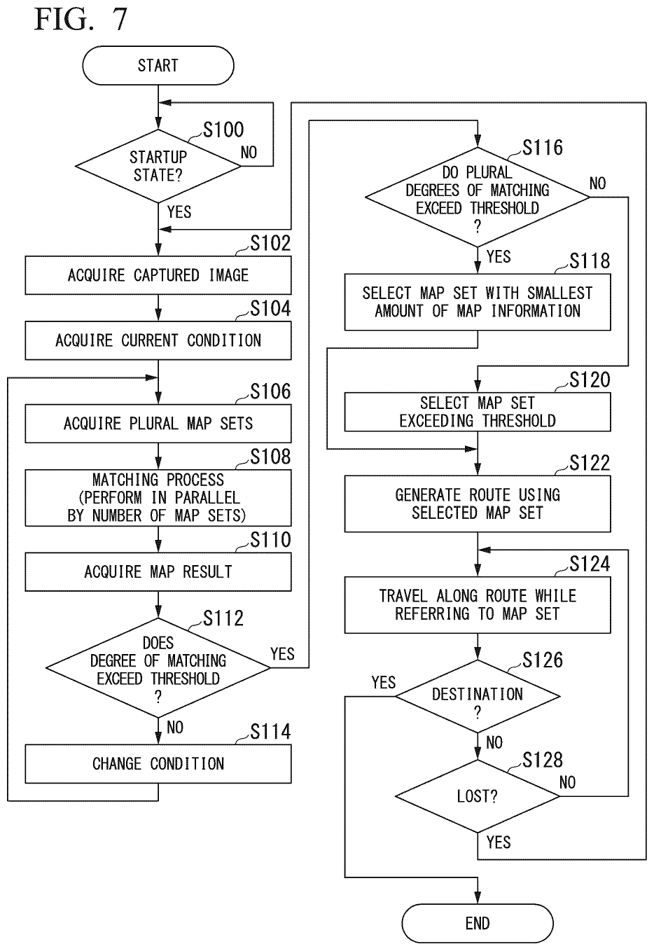

FIG. 7 is a flowchart illustrating an example of a processing procedure of the control device 200 in the embodiment. The process shown in FIG. 7 is executed when the control device 200 has established communication with the mobile object 100 or when the mobile object 100 is traveling in the following mode or the guidance mode.

First, the control device 200 determines whether the mobile object 100 is in a startup state (step S100). The control device 200 determines that the mobile object is in a startup state, for example, when power is turned on to the mobile object 100 and communication with the mobile object 100 is established, but the mobile object has not been traveling for a predetermined period of time. The control device 200 waits in a case where the mobile object is not in a startup state (step S100: NO), and advances the process to step S102 in a case where it is in a startup state (step S100: YES).

The recognition unit 202 acquires a captured image obtained by capturing an image of the surrounding situation of the mobile object 100 (step S102). Next, the recognition unit 202 acquires the current conditions (step S104). The recognition unit 202 may, for example, acquire conditions (such as the arrangement of obstacles) accepted by the terminal device 2, or may acquire conditions (such as a GPS signal or illuminance) acquired by a sensor (not shown) of the mobile object 100. Next, the recognition unit 202 acquires a plurality of map sets by classifying the map information 222 according to the current conditions (step S106).

Next, the recognition unit 202 performs a matching process of calculating the degree of matching between the captured image acquired in step S102 and each of the plurality of map sets (step S108). The matching process is performed in parallel for each of the plurality of map sets.

The recognition unit 202 acquires a plurality of degrees of matching corresponding to the plurality of map sets as matching results (step S110). The recognition unit 202 determines whether there is a degree of matching exceeding a threshold among the plurality of degrees of matching (step S112). In a case where there is no degree of matching exceeding the threshold (step S112: NO), the recognition unit 202 changes a predetermined condition (step S114), and repeats step S106 and the subsequent steps. In a case where there is a degree of matching exceeding the threshold (step S112: YES), the recognition unit 202 determines whether a plurality of degrees of matching exceed the threshold (step S116).

In a case where the plurality of degrees of matching do not exceed the threshold (step S114: NO), the recognition unit 202 selects a map set corresponding to a degree of matching exceeding the threshold (step S120). In a case where the plurality of degrees of matching exceed the threshold (step S116: YES), the recognition unit 202 may select a map set with the smallest amount of information among the map sets corresponding to the plurality of degrees of matching (step S118). Without being limited to this, the map set may be selected using other conditions such as, for example, selecting a map set with the highest degree of matching.

Next, the recognition unit 202 estimates the self-position using the selected map set, and the route generation unit 204 generates a route from the estimated self-position to the destination (step S112). Next, the drive control unit 206 causes the mobile object 100 to travel on the basis of the route generated by the route generation unit 204 (step S124). In this case, the recognition unit 202 estimates the self-position by matching the map included in the selected map set with the captured image acquired from the mobile object 100, while the drive control unit 206 can cause the mobile object to travel the self-position estimated by the recognition unit 202 toward the destination.

The control device 200 determines whether the self-position estimated by the recognition unit 202 has reached the destination (step S126), and ends the process of this flowchart in a case where the self-position has reached the destination (step S126: YES). The control device 200 determines whether it has been lost by the recognition unit 202 (step S128). The control device 200 determines that it has been lost, for example, when the degree of matching between an image obtained by capturing an image of the vicinity of the mobile object 100 and a map included in the map set currently being referenced falls below a lower limit. In a case where it has not been lost, the control device 200 repeats step S124 and the subsequent steps (step S128: NO), and in a case where it has been lost, the control device repeats step S102 and the subsequent steps (step S128: YES). In step S104 in a case where it has been lost, the control device 200 may acquire a map set according to conditions different from the conditions adopted in the previous time.

As described above, according to the control device 200 of the mobile object 100 of the embodiment, the self-position of the mobile object is estimated on the basis of the map set including a plurality of images obtained by capturing images of the vicinity of the mobile object 100 and a plurality of pieces of map information 222. In this case, the recognition unit 202 can acquire a plurality of map sets each including a plurality of maps, perform a matching process for each of the map sets between each of the plurality of maps included in each map set and an image obtained by capturing an image of the vicinity of the mobile object 100, select any of the plurality of map sets on the basis of a plurality of matching results corresponding to the plurality of map sets, and estimate the self-position of the mobile object 100 on the basis of at least one of the map information 222 included in the selected map set. Thereby, according to the control device 200 of the mobile object 100, it is possible to perform processes such as estimating the self-position while suppressing the amount of processing even in a case where a large number of pieces of map data are present.

The above-described embodiment can be represented as follows.

A mobile object control device including:
a storage medium having computer-readable instructions stored therein;
a processor connected to the storage medium;
the processor executing the computer-readable instructions,
a recognition unit configured to estimate a self-position of a mobile object on the basis of an image obtained by capturing an image of a vicinity of the mobile object and a map;
a generation unit configured to generate a route from the mobile object to a destination on the basis of the estimated self-position, the destination, and the map; and
a control unit configured to control the mobile object so that the mobile object moves to the destination along the generated route,
wherein the recognition unit acquires a plurality of map sets each including a plurality of the maps, performs a matching process for each of the map sets between each of the plurality of maps included in each map set and an image obtained by capturing an image of a vicinity of the mobile object, selects any of the plurality of map sets on the basis of a plurality of matching results corresponding to the plurality of map sets, and estimates the self-position of the mobile object on the basis of at least one of the maps included in the selected map set.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A mobile object control device comprising:
a recognition unit configured to estimate a self-position of a mobile object on the basis of an image obtained by capturing an image of a vicinity of the mobile object and a map;
a generation unit configured to generate a route from the mobile object to a destination on the basis of the estimated self-position, the destination, and the map; and
a control unit configured to control the mobile object so that the mobile object moves to the destination along the generated route,
wherein the recognition unit acquires a plurality of map sets each including a plurality of the maps, performs a matching process for each of the map sets between each of the plurality of maps included in each map set and an image obtained by capturing an image of a surrounding situation of the mobile object, selects any of the plurality of map sets on the basis of a plurality of matching results corresponding to the plurality of map sets, and estimates the self-position of the mobile object on the basis of at least one of the maps included in the selected map set.

2. The mobile object control device according to claim 1, wherein the recognition unit performs a plurality of matching processes corresponding to the plurality of map sets in parallel.

3. The mobile object control device according to claim 1, wherein the recognition unit selects, from among the plurality of map sets, a map set with a least amount of information out of map sets whose degree of matching exceeds a threshold.

4. The mobile object control device according to claim 1, wherein the recognition unit performs the matching process when the mobile object is started up or when the degree of matching between an image obtained by capturing an image of the vicinity of the mobile object and a map included in the map set being referred to falls below a lower limit.

5. The mobile object control device according to claim 1, wherein the plurality of maps included in each of the map sets are maps that satisfy predetermined conditions.

6. The mobile object control device according to claim 5, wherein each of the predetermined conditions is a proximity of a position, a time, or lighting conditions.

7. The mobile object control device according to claim 1, wherein the plurality of map sets differ from other map sets in lighting conditions or sunlight conditions.

8. The mobile object control device according to claim 1, wherein the plurality of map sets differ from other map sets in obstacle conditions including an arrangement of obstacles.

9. A method of controlling a mobile object causing a computer to:
estimate a self-position of a mobile object on the basis of an image obtained by capturing an image of a vicinity of the mobile object and a map;
generate a route from the mobile object to a destination on the basis of the estimated self-position, the destination, and the map;
control the mobile object so that the mobile object moves to the destination along the generated route; and
when the self-position is estimated, acquire a plurality of map sets each including a plurality of the maps, perform a matching process for each of the map sets between each of the plurality of maps included in each map set and an image obtained by capturing an image of a surrounding situation of the mobile object, select any of the plurality of map sets on the basis of a plurality of matching results corresponding to the plurality of map sets, and estimate the self-position of the mobile object on the basis of at least one of the maps included in the selected map set.

10. A computer readable non-transitory storage medium having a program stored therein, the program causing a computer to:
estimate a self-position of a mobile object on the basis of an image obtained by capturing an image of a vicinity of the mobile object and a map;
generate a route from the mobile object to a destination on the basis of the estimated self-position, the destination, and the map;
control the mobile object so that the mobile object moves to the destination along the generated route; and
when the self-position is estimated, acquire a plurality of map sets each including a plurality of the maps, perform a matching process for each of the map sets between each of the plurality of maps included in each map set and an image obtained by capturing an image of a surrounding situation of the mobile object, select any of the plurality of map sets on the basis of a plurality of matching results corresponding to the plurality of map sets, and estimate the self-position of the mobile object on the basis of at least one of the maps included in the selected map set.
